(19) United States
(12) Patent Application Publication
(10) Pub. No.: US 2014/0304611 A1
(43) Pub. Date: Oct. 9, 2014

(54) Mobile Terminal and a Method of Remotely Controlling a Home Media Device Via the Mobile Terminal

(71) Applicant: MAXWAY ELECTRONICS CO.,LTD, Shenzhen (CN)

(72) Inventor: MIN GUO, Shenzhen (CN)

(73) Assignee: Maxway Electronics Co.,Ltd, Shenzhen (CN)

(21) Appl. No.: 13/864,173

(22) Filed: Apr. 16, 2013

(30) Foreign Application Priority Data
Dec. 14, 2012 (CN) 201210544123.2

(51) Int. Cl. H04L 29/08; G06F 3/0484

(52) U.S. Cl. CPC H04L 67/025; G06F 3/04842
USPC 715/740

(57) ABSTRACT

The invention provides a mobile terminal and a method of remotely controlling a home media device by the mobile terminal. The method comprises: sending request message of acquiring application list from the mobile terminal to the home media device, and after the receipt of the application list from the home media device, the application list is displayed by the mobile terminal in the form of shortcuts; once a shortcut corresponding to an application being selected, control command corresponding to the selected application being sent from the mobile terminal to the home media device; once the control command being sent from the mobile terminal to the home media device, the mobile terminal redirecting to a control page corresponding to at least one controller for user's selecting operation. By implementing the invention, applications in the home media device could be launched directly by the mobile terminal. The mobile terminal automatically redirects to a control page corresponding to at least one controller for user's selecting operation, which provides great convenience for user's operation since the user doesn't need to press corresponding return key to display the control page.

### CROSS REFERENCE TO RELATED APPLICATIONS

This non-provisional patent application claims priority under 35 U.S.C. §119(a) from Patent Application No. 201210544123.2 filed in The People's Republic of China on December 14, 2012.

### FIELD OF THE INVENTION

This invention generally relates to wireless communication, and particularly to a method of remotely controlling a home media device via a mobile terminal.

### BACKGROUND OF THE INVENTION

Handheld device's applications are becoming more and more common. There are more and more proposals of using a handheld device to control other devices in the same network, such as a mouse, a remote-controller, a keyboard, etc. However, to remotely launch a remote application, control device is required to select a shortcut corresponding to the remote application, which is inconvenient for a user to operate.

### SUMMARY OF THE INVENTION

The present invention provides a mobile terminal and a method of remotely control a home media device via a mobile terminal. By implementing the invention, applications in the home media device could be launched directly by the mobile terminal, which provides great convenience for user's operation. Once control command corresponding to the applications is sent from the mobile terminal to the home media device, the mobile terminal automatically redirects to a control page corresponding to at least one controller for user's selecting operation, which also provides great convenience for user's operation since the user doesn't need to press corresponding return key to display the control page.

Accordingly, in one aspect thereof, the present invention provides a method of remotely controlling a home media device via a mobile terminal. The method comprises a step of establishing WiFi wireless connection between the home media device and the mobile terminal that has a touch control screen. The method further comprises a step of sending request message of acquiring application list from the mobile terminal to the home media device, and after the receipt of the application list from the home media device, displaying the application list on the mobile terminal in the form of shortcuts. The method further comprises a step of selecting a shortcut that corresponding to an application, and sending the control command corresponding to the selected application from the mobile terminal to the home media device. The method further comprises a step of decoding the control command by the home media device and launching the corresponding application. The method further comprises a step of, by sending the control command from the mobile terminal to the home media device, the mobile terminal redirecting to a control page corresponding to at least one controller for user's selecting operation. The method further comprises a step of, by selecting a control mode of a controller for operation, sending the control command corresponding to the control mode to the home media device based on the control mode of the controller.

In another aspect thereof, the present invention provides a mobile terminal comprising a touchpad for displaying shortcuts of application list and a control page corresponding to at least one controller for use's selecting operation. The mobile terminal further comprises a data connection module for establishing WiFi wireless connection to a home media device, and a transceiving module for sending request message of acquiring application list to the home media device, and receiving application list from the home media device. The mobile terminal further comprises a processing module. The processing module is adapted to display the application list received by the transceiving module in the touchpad in the form of shortcuts. The processing module is further adapted to send control command corresponding to the selected application to the home media device via the transceiving module once a shortcut of an application being selected. The processing module is further adapted to redirect the touchpad to display a control page corresponding to at least one controller for user's selection, once the control command corresponding to the selected application is sent to the home media device via the transceiving module. The processing module is further adapted to send control command corresponding to the control mode to the home media device based on the control mode of the controller, once a control mode of a controller is selected by user to operate.

By implementing the invention, application list of the home media device is displayed in the mobile terminal. Applications in the home media device could be launched directly by the mobile terminal. Once control command corresponding to the applications is sent from the mobile terminal to the home media device, the mobile terminal automatically redirects to a control page corresponding to at least one controller for user's selecting operation, which provides great convenience for user's operation since the user doesn't need to press corresponding return key to display the control page.

### BRIEF DESCRIPTION OF THE DRAWINGS

Various embodiments of the present invention are described, by way of example only, with reference to the drawings, in which identical or related structures, elements, or parts may be labeled with the same reference numerals throughout the figures. Dimensions of components and features shown in the figures are generally chosen for convenience and clarity of presentation and are not necessarily to scale.

FIG. 1 is a flow chart of the method of remotely controlling a home media device via a mobile terminal according to an exemplary embodiment of the present invention;

FIG. 2 is a schematic block diagram of a mobile terminal according to an exemplary embodiment of the present invention.

### DETAILED DESCRIPTION OF VARIOUS EMBODIMENTS

Various embodiments of the present invention are described, by way of example only, with reference to the drawings.

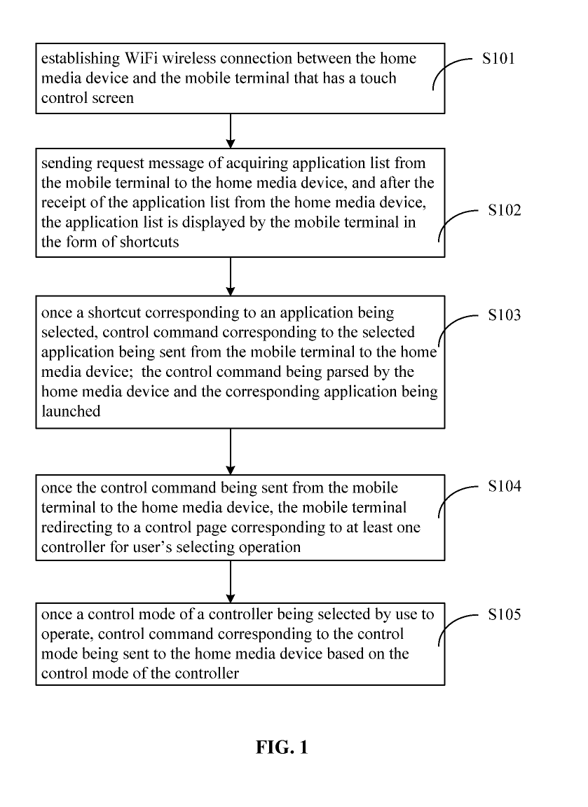

Referring to FIG. 1, according to the present invention, a method of remotely controlling a home media device via a mobile terminal comprises the following steps:

At S101, wires connection is established via WiFi between the mobile terminal that has a touch control screen and the home media device.

At S102, request message for acquiring application list is sent to the home media device from the mobile terminal. After the receipt of the application list, the application list is displayed in the form of shortcuts. At the moment, a user can selectively launch a corresponding application, and directly launch the corresponding application of the home media device via the mobile terminal.

At S103, when a shortcut to one of the applications is selected, control command corresponding to the selected application is sent from the mobile terminal to the home media device. The control command is parsed by the home media device, and the application corresponding to the control command is launched.

At S104, after the sending of control command from the mobile terminal to the home media device, the mobile terminal redirects to a control page that displays at least one controller available for users to select and operate. It provides great convenience to users to operate, since the users can see the control page without press corresponding return key.

The controller could be a mouse, a keyboard, a remote controller or a touchpad. Control program corresponding to the controllers is integrated to the mobile terminal. The control page is shown in the display screen of the mobile terminal for user's selecting operation. If a user selects the mouse, then a control page of the mouse is shown in the touch control screen for the user to operate.

At S105, when the user selects one of the controllers to operate, according to control mode of the selected controller, control command corresponding to the control mode is sent to the home media device.

The function of automatically redirecting to a control page could be pre-configured to the mobile terminal. After the sending to corresponding control command corresponding to selected application from the mobile terminal to the home media device, the mobile terminal determine if a control page corresponding to at least one controller is pre-configured to be redirected to after the launching of an application. If yes, redirecting to the control page for user's selecting operation. This configuration adapts users' habits.

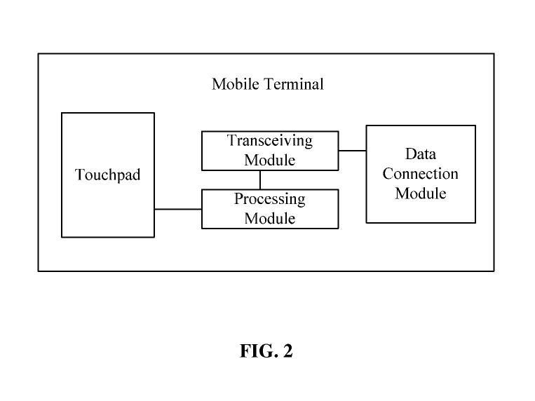

Referring to FIG. 2, a mobile terminal, according to the present invention, comprises a touch control screen for establishing WiFi wireless connection between the mobile terminal and the home media device. The mobile terminal further comprises a transceiving module for sending request message to the home media device to acquire application list.

The mobile terminal further comprises a processing module for displaying the application list received by the transceiving module in the touch control screen in the form of shortcuts. When one of the shortcuts is selected by a user, the processing module sends control command corresponding to the selected application to the home media device via the transceiving module. After the sending of the control command corresponding to the selected application to the home media device via the transceiving module, the processing module redirects the touch control screen to display a control page corresponding at least one controller for user's selecting operation. When the user selects a control mode of one of the controllers to operate, based on the control mode, the processing module sends control command corresponding to the control mode to the home media device.

In addition, after the sending of control command corresponding to the selected application to the home media device, the processing module determines if the function of redirecting to a control page corresponding to at least one controller after the launching of an application is pre-configured. If yes, the touch control is redirected to display the control page for use's selecting operation.

Although the invention is described with reference to one or more preferred embodiments, it should be appreciated by those skilled in the art that various modifications are possible. Therefore, the scope of the invention is to be determined by reference to the claims that follow.

In the description and claims of the present application, each of the verbs “comprise”, “include”, “contain” and “have”, and variations thereof, are used in an inclusive sense, to specify the presence of the stated item but not to exclude the presence of additional items.

1. A method of remotely controlling a home media device via a mobile terminal, characterized in that, the method comprises:
establishing WiFi wireless connection between the home media device and the mobile terminal that has a touch control screen;
sending request message of acquiring application list from the mobile terminal to the home media device, and after the receipt of the application list from the home media device, the application list is displayed by the mobile terminal in the form of shortcuts;
selecting a shortcut corresponding to an application , sending control command corresponding to the selected application from the mobile terminal to the home media device; decoding the control command by the home media device and launching the corresponding application;
by sending the control command from the mobile terminal to the home media device, the mobile terminal redirecting to a control page corresponding to at least one controller for user's selecting operation;
by selecting a control mode of a controller for operation, sending control command corresponding to the control mode to the home media device based on the control mode of the controller.

2. The method of claim 1, wherein the controller comprises a mouse, a keyboard, a remote-controller or a touchpad.

3. The method of claim 1, wherein after the sending of control command corresponding to selected the application to the home media device, the mobile terminal determines if a control page corresponding to at least one controller is pre-configured to be redirected to; if yes, then redirects to the control page for user's selecting operation.

4. A mobile terminal comprises:
a touchpad for displaying shortcuts of application list and a control page corresponding to at least one controller for use's selecting operation;
a data connection module for establishing WiFi wireless connection to a home media device;
a transceiving module for sending request message of acquiring application list to the home media device, and receiving application list from the home media device;
a processing module, for:
displaying the application list received by the transceiving module in the touchpad in the form of shortcuts;
once a shortcut of an application being selected, sending control command corresponding to the selected application to the home media device via the transceiving module;
once the control command corresponding to the selected application being sent to the home media device via the transceiving module, redirecting the touchpad to display a control page corresponding to at least one controller for user's selection; and
once a control mode of a controller being selected by user to operate, sending control command corresponding to the control mode to the home media device based on the control mode of the controller.

5. The mobile terminal of claim 4, wherein once the control command corresponding to the selected application being sent to the home media device, the processing module determines if a control page corresponding to at least one controller being pre-configured to be redirected to; if yes, redirecting the touchpad to the control page corresponding to at least one controller for user's selecting operation.
